(19) United States
(12) Patent Application Publication
(10) Pub. No.: US 2026/0071975 A1
(43) Pub. Date: Mar. 12, 2026

(54) CONFORMAL COMPENSATING FILTER FOR ENHANCED RADIOGRAPHIC IMAGING OF OBJECTS

(71) Applicant: Government of the United States as represented by the Secretary of the Air Force, Wright-Patterson AFB, OH (US)

(72) Inventors: Daniel Sparkman, Beavercreek, OH (US); Michael Uchic, Dayton, OH (US); Edwin Schwalbach, Kettering, OH (US)

(21) Appl. No.: 19/285,110

(22) Filed: Jul. 30, 2025

Related U.S. Application Data
(60) Provisional application No. 63/693,884, filed on Sep. 12, 2024.

(51) Int. Cl. G01N 23/046; G01N 23/20008

(52) U.S. Cl. CPC G01N 23/046; G01N 23/20008; G01N 2223/313

(57) ABSTRACT

A system for performing enhanced radiographic imaging of objects using a conformal compensating filter is disclosed. The system includes: a source of radiation; a detector for detecting the radiation; a test object comprising an outer surface; and a conformal compensating filter comprising an inner surface. The source emits radiation towards the test object such that the radiation interacts with the test object and is detected by the detector to provide information about the test object. The conformal compensating filter reduces the variation in measured intensity of the emitted radiation at the detector to increase the relative information about defects in the test object. The conformal compensating filter surrounds the test object such that the inner surface of the conformal compensating filter mirrors the outer surface of the test object for at least a portion of the outer surface of the test object.

### RIGHTS OF THE GOVERNMENT

The invention described herein may be manufactured and used by or for the Government of the United States for all governmental purposes without the payment of any royalty.

Pursuant to 37 C.F.R. § 1.78(a)(4), this application claims the benefit of and priority to prior filed co-pending Provisional Application Ser. No. 63/693,884, filed Sep. 12, 2024, which is expressly incorporated herein by reference in its entirety.

### FIELD OF THE INVENTION

The present invention relates generally to radiographic imaging and, more particularly, to conformal compensating filters for enhanced radiographic imaging of objects.

### BACKGROUND OF THE INVENTION

Radiography and computed tomography expose objects including manufactured parts and inorganic and organic structures (e.g., human bones, etc.) to x-rays to produce images of the object's internal and external features. In engineering, maintenance, and medical applications, radiographs are collected to ascertain the presence of features such as defects that very often are located in proximity to large geometric features. Computed tomography produces 3D volumetric reconstructions of an object. Radiographic and tomographic images of objects are dominated by the larger geometric features, which then occludes, obscures, or introduces image artifacts that make it difficult to detect small features, particularly internal ones such as defects, cavities, and passages. A need exists to mitigate the impact of large geometric features to enhance the imaging of the small features of interest.

### SUMMARY OF THE INVENTION

The present invention overcomes the foregoing problems and other shortcomings, drawbacks, and challenges of detection, localization, and characterization of an object's internal geometrical features. While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present disclosure, a system for performing enhanced radiographic imaging of objects using a conformal compensating filter is disclosed. The system includes: a source of radiation; a detector for detecting the radiation; a test object comprising an outer surface; and a conformal compensating filter comprising an inner surface. The source is configured to emit radiation towards the test object such that the radiation interacts with the test object and is detected by the detector to provide information about the test object. The conformal compensating filter is configured to reduce the variation in measured intensity of the emitted radiation at the detector to increase the relative information about defects in the test object. The conformal compensating filter at least partially surrounds the test object and is configured such that the inner surface of the conformal compensating filter mirrors the outer surface of the test object for at least a portion of the outer surface of the test object. Additionally, the conformal compensating filter is fixed to the reference frame of the object, such that the conformal compensating filter moves and rotates with the object relative to the source and detector.

According to another aspect of the disclosure, a system for performing enhanced radiographic imaging of objects using a conformal compensating filter is disclosed. The system includes: a source of radiation; a detector for detecting the radiation; a test object comprising an outer surface; and a conformal compensating filter comprising an inner surface. The source is configured to emit radiation towards the test object such that the radiation interacts with the test object and is detected by the detector to provide information about the test object, the conformal compensating filter is configured to reduce the variation in measured intensity of the emitted radiation at the detector to increase information about defects in the test object, the conformal compensating filter at least partially surrounds the test object forming a cavity between corresponding portions of the inner surface of the conformal compensating filter and the outer surface of the test object and the cavity is filled with an attenuating media, and the conformal compensating filter is fixed to the reference frame of the object, such that the conformal compensating filter moves and rotates with the object relative to the source and detector.

According to yet another aspect of the present disclosure, a process of generating information about a test object using radiation filtered by a conformal compensating filter includes emitting radiation towards the test object. The radiation is emitted using a system including: a source of radiation; a detector for detecting the radiation; the test object comprising an outer surface; and a conformal compensating filter comprising an inner surface. The conformal compensating filter is configured to reduce the variation of measured intensity at the detector of radiation emitted by the source, the conformal compensating filter at least partially surrounds the test object and is configured such that the inner surface of the conformal compensating filter mirrors the outer surface of the test object for at least a portion of the outer surface of the test object, and measuring the radiation with the detector to determine information about the test object.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 shows a system for collecting radiographs for 2D radiography or 3D computed tomography according to one or more embodiments shown and described herein.

FIG. 2 shows an exemplary configuration of a conformal compensating filter containing an object with internal defects highlighted.

FIG. 3 shows various charts based on simulated tests completed with the system of FIG. 2 for various powder packing densities within the conformal compensating filter.

FIG. 4 shows aspects of a conventional x-ray computed tomography simulation of a test piece.

FIG. 5 shows aspects of an x-ray computed tomography simulation of a test piece with a conformal compensating filter with a 50% powder packing fraction.

FIG. 6 shows aspects of the x-ray computed tomography simulation of a test piece with a conformal compensating filter with a 95% powder packing fraction.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

Non-destructive evaluation (NDE) techniques are important to detect, localize, and characterize defects during quality assurance and quality control (QA/QC) of components and parts. Some parts, particularly those fabricated with Additive Manufacturing (AM), may have complex geometries or rough surfaces, which can limit which NDE techniques can be usefully applied. Radiography, a 2D technique, and X-ray Computed Tomography (XCT), a 3D radiography technique, have demonstrated applicability to NDE of parts with complex geometry and rough surfaces.

Radiography (2D) may be limited to relatively simple object geometries or local regions of an object where object geometry is relatively simple. This is in part because objects with complex geometries may have large differences in material path length, with corresponding large differences in x-ray attenuation and image latitude. A high dynamic range is then necessary for the radiographs to capture all image intensity variation due to the object geometry. It can be challenging to accurately detect, localize, and characterize small internal porosities and defects against the background of large image intensity variation due to object geometry in a single radiograph. Computed tomography is a 3D technique that somewhat overcomes the issue of the object geometry dominating an individual radiograph, but the complex geometry results in image artifacts due to beam hardening and scatter that can still make accurate defect detection, localization, and characterization challenging.

Improved techniques, such as compensating filters may enhance 2D radiographic imagery making it more useful for inspecting objects and structures. Compensating filters can be used to selectively filter an x-ray beam more in one region than others during an x-ray examination of a specimen in order to compensate for the part having a non-flat shape. However, conventional compensating filters have relatively simple geometries, and are useful for imaging of simple geometries. Conventional compensating filters are insufficient for imaging defects for objects with complex internal and/or external geometries. The systems, features, and techniques described herein may resolve one or more of the insufficiencies of the prior art.

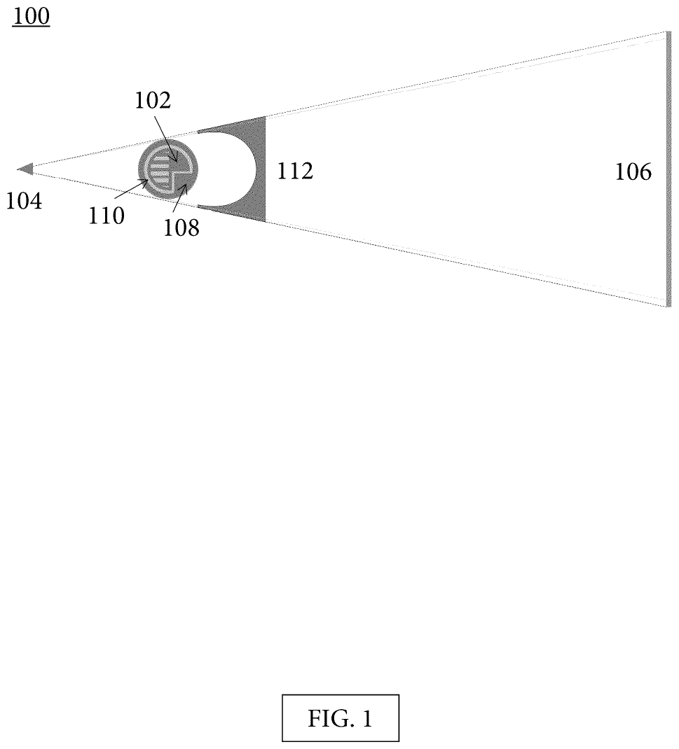

FIG. 1 shows a system 100 for conducting radiography and computed tomography. The system 100 includes an object 102 that can be imaged using a source 104 of x-ray or other radiation and a detector 106. The object 102 can be positioned on, for example, a stage (not shown) that can move (e.g., rotate) the object 102 to image the object in various orientations with respect to the source 104 and the detector 106. Likewise, in embodiments, the source 104 and/or the detector 106 are moveable with respect to the object 102 via various mechanisms (not shown). The system 100 also includes a conformal compensating filter, comprised of an outer shell 108, an attenuating media 110, and a static compensating filter 112. The attenuating media 110 may fill any open passages in the object as well as the cavity 114 between the conformal compensating filter 108 and the object 102. In the system 100 shown, the static compensating filter 112 is a bowtie filter.

The source 104 and the detector 106 (e.g., image receptor) may be separated by some distance. In some configurations, the object 102 is positioned on a straight-line path between the source 104 and the detector 106. Common radiation sources include, for example, x-ray tubes. Common image receptors include, for example, recording media such as film or digital flat panel detectors sensitive to x-rays. Conventional methods of adjusting image quality and detail can include adjusting the accelerating voltage and/or current supplied to the x-ray tube, the relative distances between the source, object, and detector, and a set amount of exposure time for collecting the image. Radiographs (projection images) are recorded by the detector and capture the intensity of x-ray photons that exit the x-ray source and arrive at the x-ray detector. Some of the x-ray photons interact with the object and are absorbed, scattered, or otherwise attenuated, while the remaining ones are transmitted through to the detector.

The geometrical shape of the object 102, material density, and material composition are some factors than can affect exposure in a radiograph. The x-ray photon paths with lower transmission intensities measured at the detector 106 travel from the source 104 through more attenuating portions of the view, which are typically the thicker and/or denser portions of the object for a given object orientation. The x-ray photon paths with higher transmission intensities measured at the detector travel from the source 104 through less attenuating portions of the view, which typically are regions where the object is thinner, less dense, or not in the path between the source 104 and detector 106. The two extremes form the darkest and brightest parts of a radiograph, and determine the exposure ranges the radiographic apparatus must be adjusted to accommodate for. Inability to adjust the dynamic range sufficiently can result in data censoring and loss of detail due to overexposure and underexposure in parts of the image.

Small internal features such as pores and defects cause small changes in x-ray attenuation relative to the larger object geometric features in the resulting radiograph. If the x-ray system settings are adjusted to account for the extremes in intensity that are due to the object shape, this necessarily limits the ability to detect small fluctuations due to small defects.

In X-ray Computed Tomography (XCT), multiple projection images are collected at different view angles and then processed with a reconstruction algorithm to assemble a 3D volumetric representation of the object and any internal features. The 3D reconstruction may contain image artifacts such as streaks and cupping. Streaking often appears as light or dark shadows coming from edges and corners of the object. Cupping often appears as bright halos near outer surfaces. These XCT artifacts make accurate detection and sizing of defects challenging and are generally attributed to the phenomena of “beam hardening” and scatter, which result in fewer or greater numbers of photons measured by the detector than predicted by primary transmission alone. Beam hardening is a phenomenon that results in the typically greater attenuation of relatively low energy photons as x-rays pass through materials (that is, the average energy of the remaining photons is higher after passing through the material). Another factor determining the severity of beam-hardening artifacts is the presence of complicated object geometry with sharp changes in material path length due to corners, internal passages, and other common geometric features. X-ray scatter involves photons interacting with material and diverting to different locations on the detector flat panel than their original ray path. Both of these phenomena impact XCT reconstruction image quality.

An x-ray filter is a piece of material placed in the x-ray beam path to change the spectrum of x-rays used to produce a radiograph, generally reducing the proportion of lower energy photons compared to harder, high energy photons in the beam. Most commonly, an x-ray filter is a flat thin disc or strip of metal or other material with desired attenuation properties placed between the x-ray source and the object. The effect of the filter is to reduce measured intensity at all locations in the image and increase the relative proportion of x-ray photons transmitted through the object. This results in partially mitigating both upper and lower extremes in intensity in radiographs. However, the object geometry will still dominate the image intensity variation, challenging the detection of internal defects. In XCT reconstructions, using an x-ray filter can reduce the severity of beam hardening artifacts.

A compensating filter is a type of non-flat x-ray filter designed with a geometric shape based on the object of interest. The longer path through the filter material for x-rays to travel for some regions of the image compensates for the thinner and less attenuating regions of the object to produce an image that is more equalized in intensity. Common compensating filters have “boomerang”, trough, wedge, and bowtie shapes, and are used in healthcare for imaging of corner, cylindrical, tapered, and elliptical-shaped regions of the body respectively, such as the shoulders, forearms, feet, and chest. The simple shapes help provide more contrast and detail across all regions of the radiograph, including regions that might have been too bright or dark to usefully distinguish features of interest. However they only provide a coarse intensity equalization, and work best with smoothly varying object shapes without sharp corners or fine features.

Adjustable and adaptive compensating filters have been proposed for more precise control over the local attenuation to achieve an even more uniform intensity radiograph. A disadvantage of these approaches is that additional design or feedback information is needed in the form of preliminary radiographs, MRIs, or others are needed to adjust the shape of the compensating filter. Additionally, there are constraints on the spatial resolution due to spatial averaging for the feedback mechanism, the resolution of the filter shape adjustments, and/or the time and cost of compensating filter fabrication. The constraints on spatial resolution limit the capability of adjustable compensating filters alone to usefully support imaging of objects with fine external geometric features without degradation of imaging fine internal geometric features such as defects.

By contrast, conformal compensating filters, such as the conformal compensating filter 108, can provide capabilities for imaging geometric details with more precision than static filters alone. A conformal compensating filter has a geometry that conforms to the exterior geometry of the object to be imaged. It can be a fully solid filter that encloses the object, or it can composed of a combination of solid attenuation shell and an attenuating media that fills the space between the outer shell and the object. Attenuating media, such as the attenuating media 110, can be composed of a collection of different materials (e.g., powders, particles, fluids, slurries, gels, pastes, etc.) that are more precisely matched to the attenuation properties of the object to be imaged. In some embodiments of the invention, the use of small particles, fluids, pastes, gels and/or gases for the attenuating media enable the compensating filter to conform to the shape of the object, even for very complex geometry with small features. In some embodiments, the shape adaptation can happen naturally based on the characteristics of the attenuating media. For example, the attenuating media can be space-filling and does not require any feedback and control system.

One advantage of using a conformal compensating filter is that the radiographic apparatus can be optimized to have much higher sensitivity to detect small, local changes in intensity in the x-ray images, even when the object has significantly complex geometry. The conformal compensating filter (i.e., the combined shell and attenuating media) compensates for the potential change in x-ray intensity on the x-ray detector due to the geometrical shape of the component, and the resulting x-ray image is more uniform in intensity. This results in decreasing the total range of x-ray intensities that are measured by the detector. Because the total range in x-ray intensities is much smaller, the operation of the detector can be adjusted, such as the exposure time, offset, and gains, such that contrast between the small feature signal and the background is enhanced. The theoretical optimal image able to be produced with conformal compensating filters is a completely uniform background with only the internal features such as defects visible.

Moreover, conformal compensating filters may be relatively easy to fabricate and embody a more general usage than conventional compensating filters. For example, no intermediate scan with x-ray, MRI, or other imaging technique is necessary to determine the object geometry. That is, the conformal nature of the conformal compensating filter is accomplished by inserting the attenuating media to fill the gap between the attenuating shell and the object. In some embodiments of the invention, some or all of the conformal compensating filter (both the container and any internal media), and the static attenuating filter (e.g., bowtie filter) may be re-used on other objects to minimize material usage and costs.

Still referring to FIG. 1, the conformal compensating filter 108 may have an external geometry of a desired shape (e.g., a simple shape, such as a cylinder, rectangular prism or sphere). In some embodiments, the conformal compensating filter 108 can have an internal geometry that conforms to the external geometry of the object 102 being imaged. The external geometry of the conformal compensating filter 108 can consist of a rigid or semi-rigid container (i.e., shell) of a thickness and material sufficient for holding a specific shape or shapes during imaging. The internal geometry of the conformal compensating filter 108 can take several forms.

In some embodiments, the conformal compensating filter 108 is a container with an inner surface matched closely to the outer surface of the object 102, while leaving a gap between the two that is filled with the attenuating media 110 (which may be made up of one or more of different materials such as, for example, solids, powders, particles, pastes, gels, slurries, etc.)

In other embodiments, the conformal compensating filter 108 is a fully solid object, with an inner surface matched as closely as possible to the outer surface of the object 102. In yet other embodiments, the conformal compensating filter 108 has an inner surface in the shape of a cylinder of a smaller radius than the outer surface, such that the overall shape is that of a hollow cylinder container. The cavity between the inner surface and the object 102 may be filled with an attenuating media made up of some collection of different materials, powders, particles, gels, slurries, and solids.

In each of the embodiments, the conformal compensating filter 108 acts as an attenuation shell, which may be combined with other filters, such as the static compensating filter 112 (e.g., bowtie filter), in order to transform the intensity range of the radiographic projection(s). This may result in more uniform image(s) with reduced variance.

The radiographic apparatus imaging parameters can be adjusted, which could include increasing the exposure time, gains, and offset in a manner outside the envelope of normal x-ray acquisition imaging parameters. With optimal design and use of the attenuation shell, these adjustments result in an increase in the total range of image intensity in thicker regions of an imaged object without saturating regions of the image where the object is thinner or absent. This may enhance the sensitivity for detecting defects, pores, and small internal and external geometric features by significantly reducing the large-scale changes in intensity and image artifacts due to the external geometry of the object.

In some embodiments, the conformal compensating filter can be a fully solid object, with an inner surface matched as closely as possible to the outer surface of the object. In some embodiments, the conformal compensating filter 108 is a container with an inner surface matched closely to the outer surface of the object 102, while leaving a gap between the two that is filled with an attenuating media made up of some collection of different materials, solids, powders, particles, pastes, gels, slurries, etc. In some embodiments, the conformal compensating filter has an outer surface in the shape of a sphere. The corresponding conventional compensating filter (e.g., static compensating filter) can have a specific shape with increasing thickness in the corners that results in a nominally uniform intensity radiograph. The addition of a conventional compensating filter (e.g., static compensating filter) may not be needed if the conformal compensating filter is appropriately shaped to produce the desired effect of reducing the impact of the object geometry on the radiograph (or removing it entirely).

Regarding the manner and process for making and using the systems described herein, one embodiment of a method may include manufacturing of the conformal compensating filter concurrently with an object to be imaged during additive manufacturing (AM) (e.g., 3D printing, etc.) of the object. This co-printing of the conformal compensating filter could automatically enclose the object, along with a gap left between the shell and the object. In some AM processes, such as powder bed fusion, a gap may be automatically filled with an attenuating medium.

In some embodiments, the conformal compensating filter may be manufactured (e.g., via AM) separately from the object, and then assembled to enclose the object. For example, the conformal compensating filter may enclose the object with a clamshell-like joining or affixing an end-cap. Different attenuating media can be inserted between the object and the shell to produce a mixture (that may include gaps or spaces between particles) with x-ray attenuation properties that closely match that of the object and shell.

In some embodiments, the conformal compensating filter may embody a thin-walled container that is filled with a single composition or blend of powders, liquids, or liquid suspensions that is comprised to match the attenuation properties of the object to be imaged.

In each of these embodiments, a conventional compensating filter (such as a static compensating filter (e.g., bowtie filter, etc.) may be additively manufactured or manufactured with conventional fabrication methods with geometry designed specifically for a given radiographic inspection, based on conformal compensating filter geometry, detector geometry, and source-object-detector distances.

The combination of geometric and attenuation properties of the conformal and conventional compensating filters can be designed such that contribution of the object's geometry and/or average x-ray attenuation properties to the intensity in the final radiographs is greatly minimized and/or fully removed. Meanwhile, the use of the conformal compensating filter may not affect the intensity contribution due to internal features such as voids, defects, or other geometric features of interest, and therefore these features can be observed and detected more easily from the x-ray radiographs, especially when the x-ray imaging detectors are optimized to maximize the total range when using the attenuation filters. This requires positioning the conformal compensating filter containing the attenuating media and object in the correct location with respect to the conventional compensating filter and the source and detector. Depending on the design, the conventional compensating filter may be placed between the conformal compensating filter and x-ray detector or between the x-ray source and the conformal compensating filter. Some methods of using the systems described herein may include adjusting the imaging parameters such as exposure time, gains, and offset such that the average intensity in the image is near the upper range of the detector's range, and no regions of the image are saturated. Small internal features and defects will appear as regions with a higher or lower intensity relative to the background intensity. This procedure can maximize the total range of intensity for the internal features, since the intensity variation due to the object external geometry is very nearly removed.

For 2D radiography, relatively simple embodiments of the invention may utilize only a conformal compensating filter and not a conventional compensating filter. The conformal compensating filter can have an external shape such that a conventional compensating filter is not needed to produce the desired effect of a significantly uniform intensity image. One example of an object shape that may require only this relatively simple embodiment is a rectangular prism shape.

For computed tomography, the shape of the conformal compensating filter, position of the x-ray source, position of both the conformal and conventional compensating filters, and position of the x-ray detector are configured to produce a radiographic image at each projection where the contribution of the object geometrical shape is greatly minimized or eliminated. In some embodiments, the conventional compensating filter may be fixed in place relative to the x-ray source and x-ray detector and have a bowtie (hyperbolic) shape, while the conformal compensating filter containing the object and attenuating media has a cylinder shape and may be rotated relative to the rest of the radiographic apparatus. The effect of the cylinder shape is such that as the sample stage is rotated, the resulting image is nominally unchanged. Equivalently the conformal compensating filter (and object) may be fixed, and the source, conventional compensating filter, and detector may be rotated for a circular imaging trajectory. Similar to the usage in 2D radiography, the imaging parameters such as exposure time, gains, and offset may be adjusted such that the average image intensity can be near the upper limit of the detector's useful range in order to increase the total range of intensity for the internal defects.

As mentioned, in some embodiments, the conformal compensating filter can be used without a conventional compensating filter (e.g., bowtie filter). In this configuration, the object can be imaged while the conformal compensating filter may move and rotate with the object. Resulting radiographs in this case may not necessarily exhibit uniform intensity and the external geometry of the conformal compensating filter may dominate the intensity variation in the images. However, intensity variation can vary more smoothly and beam hardening artifacts may be mostly mitigated. Cupping artifacts in this case may be mostly on the outer surface of the conformal compensating filter instead of the object surface, and streak artifacts may be much reduced.

For both 2D radiography and computed tomography, collecting reference (also called background) image(s) may involve the removal of the conformal compensating filter and object, the conventional compensating filter, or both. Or they may be replaced with another fully solid object with the external shape of the conformal compensating filter, conventional compensating filter, or both, or another shape that compensates for both. The algorithm used for processing the data may be adjusted to account for which compensating filters were used to further enhance the contrast for internal features.

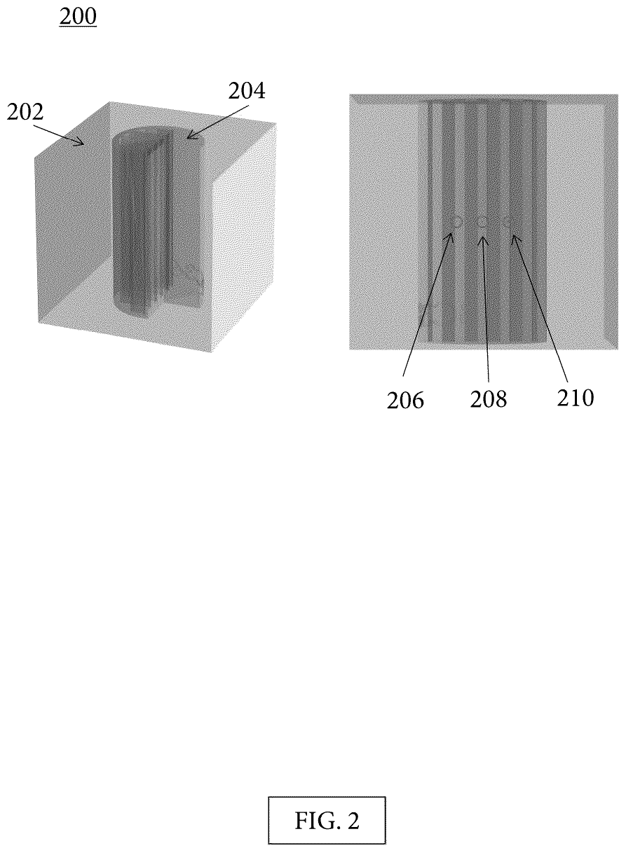

FIG. 2 shows and describes an exemplary system 200 including a conformal compensating filter 202 and a test object 204 for performing radiograph simulations using a system like the system 100 shown in FIG. 1. The test object 204 is a nearly cylindrical test object with a sector spanning 90 degrees removed. Additionally, the test object contains six parallel vertical channels that are open to the top and bottom surfaces of the cylinders. The test object 204 also includes three defects: a first defect 206, a second defect 208, and a third defect 210. The first defect 206, second defect 208, and third defect 210 are internal voids with spherical shapes of diameters 67.5, 125, and 250 μm, respectively. The conformal compensating filter 202 has an external geometry in the shape of a cube.

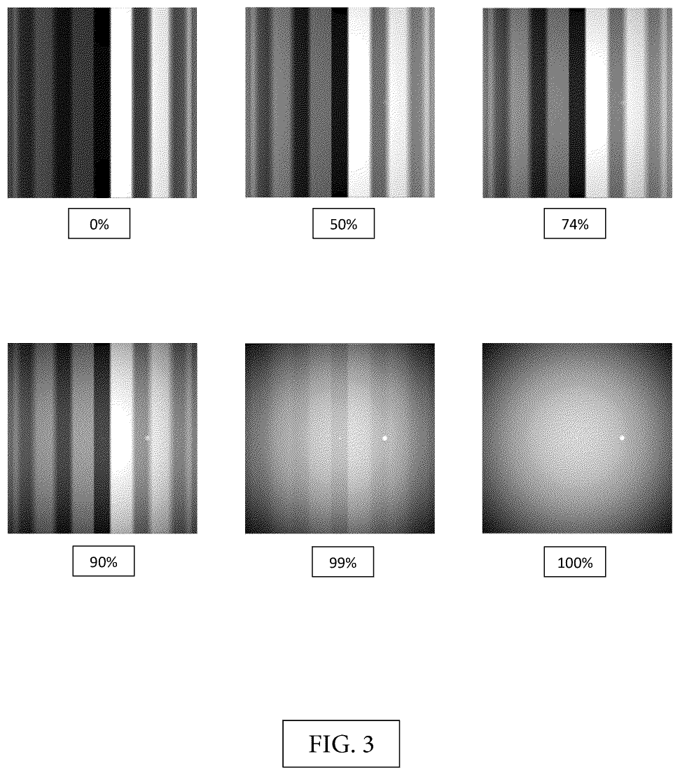

Turning to FIG. 3, six charts are shown that depict aspects of the corresponding radiograph simulations using the exemplary system 200 of FIG. 2. Each radiograph has a label indicating the powder packing density of the attenuating media within the conformal compensating filter 202. That is, the attenuating media has values between 0% and 100% of the density of the solid fully dense test object 204. As the powder packing density increases, the contrast between the voids and the defects 206, 208, 210 in the test object 204 improves as the attenuating media 110 more closely matches the x-ray attenuation properties of the test object 204.

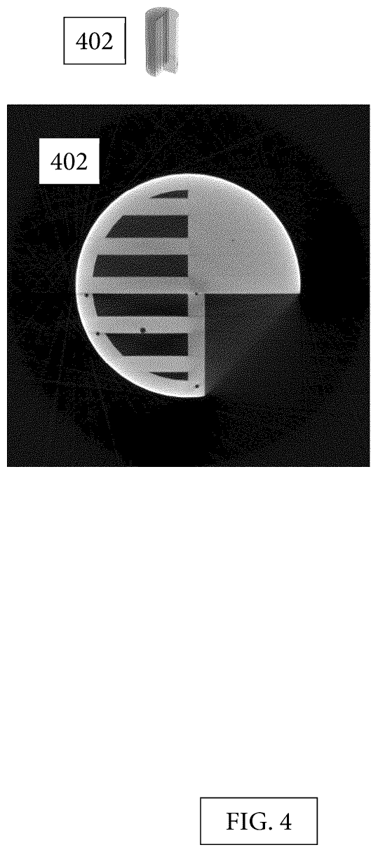

FIGS. 4-6 show aspects of three XCT simulations using a test piece 402. The test piece 402 has various defects within its structure that are visible in the tomographic reconstructions (cross sections through the center slice of the test piece 402 in FIGS. 4-6). FIG. 4 shows results of a simulation in which XCT tests of the test piece 402 were simulated without a conformal compensating filter. Significant cupping artifacts and streak artifacts are present due to beam hardening, and some of these image artifacts pass through the defects, potentially making it more challenging to accurately detect, localize, and characterize the defects.

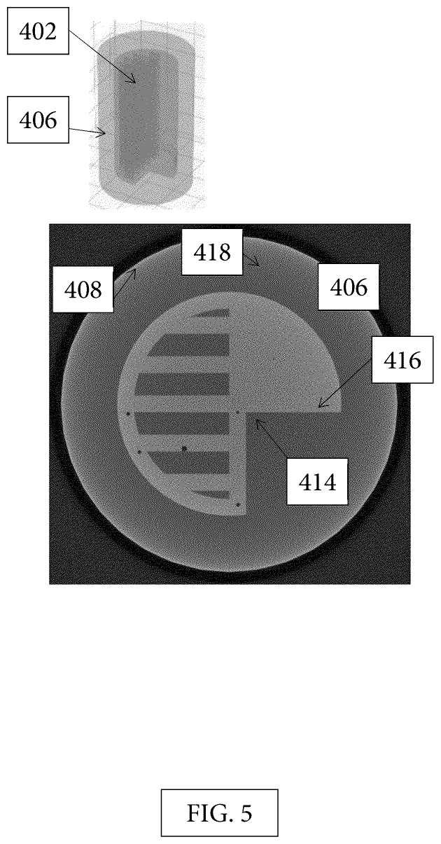

FIG. 5 shows results of a simulation in which XCT tests of the test piece 402 were simulated with a cylindrical conformal compensating filter 406 with a powder packing fraction (pf) (which can also referred to as “packing density”) of 0.5. The conformal compensating filter 406 includes a cylinder-shaped container with inner surface 408 that, together with an outer surface 416 of the test piece 402, forms a cavity 418. The cavity 418 can be filled, at least partially, with an attenuating media that can fill the cavity, conforming to the outer surface 416 of the test piece 402, for at least a portion of the outer surface 416 of the test piece. The space-filling nature of the attenuating media provides the capability to conform to reentrant corners 414. In the reconstruction, cupping and streaking artifacts are significantly reduced on the object 402.

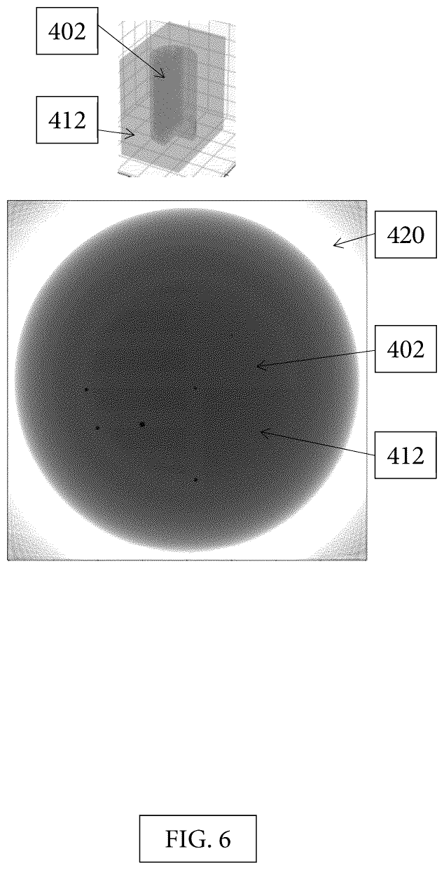

FIG. 6 shows results of a simulation in which XCT tests of the test piece 402 were simulated with a rectangular conformal compensating filter 406 with a powder packing fraction of 0.95. In the reconstruction, the contrast between the object 402 and the conformal compensating filter 412 is very small, and the defects are more easily visible. The cupping artifact due to beam hardening is more severe, but outside the region of concern in the reconstruction where the object and defects are.

The systems and methods described herein may be relevant across many commercial industries. Automotive, aerospace, defense, healthcare, security, lumber, and food processing among many others all utilize imaging of objects with complex geometries. Any field where transmission measurements are used to image internal features will benefit from the systems and methods described herein. Such fields include all ranges of the electromagnetic spectrum from radio, microwave, infrared, visible light, ultraviolet, x-rays, to gamma rays. Other applications include particle measurements (such as electron, positron, and neutron imaging) and diffusion measurements (such as thermography). The systems and methods described herein are conceptually similar to the concept of index-matching materials in optics which deals with reflection and refraction, but is specifically applied to transmission.

It should now be understood that a system for performing enhanced radiographic imaging of objects using a conformal compensating filter can include a source of radiation, a detector for detecting the radiation, a test object comprising an outer surface, and a conformal compensating filter comprising an inner surface. The source can be configured to emit radiation towards the test object such that the radiation interacts with the test object and is detected by the detector to provide information about the test object. The conformal compensating filter can be configured to reduce the variation in measured intensity of the emitted radiation at the detector to increase the relative information about defects in the test object. The conformal compensating filter can be at least partially surrounding the test object and can be configured such that the inner surface of the conformal compensating filter mirrors the outer surface of the test object for at least a portion of the outer surface of the test object. Additionally, the conformal compensating filter can be fixed to the reference frame of the object, such that the conformal compensating filter moves and rotates with the object relative to the source and detector. Such a filter can mitigate the impact of large geometric features of objects to enhance the imaging of the small features of interest within such objects.

What is claimed is:

1. A system for performing enhanced radiographic imaging of objects using a conformal compensating filter, the system comprising:
a source of radiation;
a detector for detecting the radiation;
a test object comprising an outer surface; and
a conformal compensating filter comprising an inner surface, wherein
the source is configured to emit radiation towards the test object such that the radiation interacts with the test object and is detected by the detector to provide information about the test object,
the conformal compensating filter is configured to reduce the variation in measured intensity of the emitted radiation at the detector to increase the relative information about defects in the test object,
the conformal compensating filter at least partially surrounds the test object and is configured such that the inner surface of the conformal compensating filter mirrors the outer surface of the test object for at least a portion of the outer surface of the test object, and
the conformal compensating filter is fixed to the reference frame of the object, such that the conformal compensating filter moves and rotates with the object relative to the source and detector.

2. The system of claim 1, wherein the inner surface of the conformal compensating filter and the outer surface of the test object are separated by a cavity and the cavity is filled with an attenuating media such that the attenuating media conforms to a shape of the outer surface of the test object for at least the portion of the outer surface of the test object that mirrors the inner surface of the conformal compensating filter.

3. The system of claim 2, further comprising:
a static compensating filter between the source and the detector, wherein
the static compensating filter is configured to further reduce the variation of the measured intensity of the emitted radiation at the detector and increase information about defects in the test object, and
the static compensating filter is fixed to the reference frame of the source and detector.

4. The system of claim 2, wherein the attenuating media is comprised of a combination of solids, liquids, powders, particles, pastes, gels, or slurries with a chemical composition such that its attenuation properties produce a desired amount of attenuation for a given spectrum of radiation from the source.

5. The system of claim 2, wherein the static compensating filter has a shape that depends on the exterior shape of the conformal compensating filter

6. The system of claim 2, wherein the conformal compensating filter has a simple exterior geometry, such as a rectangular prism, cylinder, or sphere.

7. The system of claim 2, wherein the test object is an additively manufactured part.

8. The system of claim 7, wherein the conformal compensating filter is an additively manufactured part.

9. The system of claim 8, wherein the conformal compensating filter and the test object are additively manufactured together.

10. A system for performing enhanced radiographic imaging of objects using a conformal compensating filter, the system comprising:
a source of radiation;
a detector for detecting the radiation;
a test object comprising an outer surface; and
a conformal compensating filter comprising an inner surface, wherein
the source is configured to emit radiation towards the test object such that the radiation interacts with the test object and is detected by the detector to provide information about the test object,
the conformal compensating filter is configured to reduce the variation in measured intensity of the emitted radiation at the detector to increase information about defects in the test object, and
the conformal compensating filter at least partially surrounds the test object forming a cavity between corresponding portions of the inner surface of the conformal compensating filter and the outer surface of the test object and the cavity is filled with an attenuating media, and
the conformal compensating filter is fixed to the reference frame of the object, such that the conformal compensating filter moves and rotates with the object relative to the source and detector.

11. The system of claim 10, wherein the attenuating media is comprised of a combination of solids, liquids, powders, particles, pastes, gels, or slurries with a chemical composition such that its attenuation properties produce a desired amount of attenuation for a given spectrum of radiation from the source and conforms to the shape of the outer surface of the test object for at least the portion of the outer surface of the test object.

12. The system of claim 11, further comprising:
a static compensating filter between the source and the detector, wherein
the static compensating filter is configured to further reduce the variation in measured intensity at the detector of radiation emitted by the source and increase relative information about defects in the test object, and
the static compensating filter is fixed to the reference frame of the source and detector.

14. The system of claim 13, wherein the static compensating filter has a shape that depends on the exterior shape of the conformal compensating filter.

15. A process of generating information about a test object using radiation filtered by a conformal compensating filter, the process comprising:
emitting radiation towards the test object using a system comprising:
a source of radiation;
a detector for detecting the radiation;
the test object comprising an outer surface; and
a conformal compensating filter comprising an inner surface, wherein
the conformal compensating filter is configured to reduce the variation of measured intensity at the detector of radiation emitted by the source, and
the conformal compensating filter at least partially surrounds the test object and is configured such that the inner surface of the conformal compensating filter mirrors the outer surface of the test object for at least a portion of the outer surface of the test object, and
measuring the radiation with the detector to determine information about the test object.

16. The process of claim 15, wherein the inner surface of the conformal compensating filter and the outer surface of the test object are separated by a cavity and the cavity is filled with an attenuating media such that the attenuating media conforms to a shape of the outer surface of the test object for at least the portion of the outer surface of the test object that mirrors the inner surface of the conformal compensating filter.

17. The process of claim 2, further comprising:
placing a static compensating filter between the source and the detector during emission of the radiation, wherein
the static compensating filter is configured to further reduce the variation of measured intensity of the emitted radiation at the detector to increase information about defects in the test object.

18. The process of claim 15, wherein the test object is an additively manufactured part.

19. The process of claim 18, wherein the conformal compensating filter is an additively manufactured part.

20. The process of claim 19, wherein the conformal compensating filter and the test object are additively manufactured together.
